(19) United States
(12) Patent Application Publication
(10) Pub. No.: US 2013/0062318 A1
(43) Pub. Date: Mar. 14, 2013

(54) WIRE DISCHARGE MACHINE

(71) Applicants: Kyoichi Ebashi, Chiyoda-ku (JP); Yoshikazu Ukai, Chiyoda-ku (JP); Koji Kiyohara, Chiyoda-ku (JP)

(72) Inventors: Kyoichi Ebashi, Chiyoda-ku (JP); Yoshikazu Ukai, Chiyoda-ku (JP); Koji Kiyohara, Chiyoda-ku (JP)

(73) Assignee: MITSUBISHI ELECTRIC CORPORATION, Chiyoda-ku, Tokyo (JP)

(21) Appl. No.: 13/698,807

(22) PCT Filed: May 21, 2010
(86) PCT No.: PCT/JP2010/058658

§ 371 Date: Nov. 19, 2012

(51) Int. Cl. B23H 7/14

(52) U.S. Cl. 219/69.13

(57) ABSTRACT

A wire discharge machine includes a wire electrode arranged with a gap from a workpiece, and a constant-voltage power supply that applies a high-frequency voltage between the workpiece and the wire electrode, and generates discharge between the workpiece and the wire electrode by applying the high-frequency voltage to machine the workpiece. The wire discharge machine further includes a current measurement unit that measures a current value of a current flowing from the constant-voltage power supply, a determination unit that determines a state between electrodes, which is a state between the workpiece and the wire electrode, based on a combination of a result of a threshold determination of the measured current value and a result of a threshold determination of a change value in the current value, and a control unit that controls a gap between the workpiece and the wire electrode based on the determined state between electrodes.

### FIELD

The present invention relates to a wire discharge machine that generates intermittent discharge by applying a voltage between electrodes, which is a gap between a wire electrode and a workpiece as the other electrode arranged opposite to each other with a predetermined gap therebetween, thereby machining the workpiece.

### BACKGROUND

A discharge machine generates discharge by applying a voltage between a tool electrode such as a wire and a workpiece to perform machining (hereinafter, the space therebetween is referred to as “machining gap” or “gap between electrodes”). In the discharge machine, it is known that a fine machining surface can be obtained by applying a high-frequency voltage to a gap between electrodes and generating discharge with a short duration with a high repetition frequency, and various techniques have been disclosed hitherto (see, for example, Patent Literatures 1 to 6).

For example, there has been disclosed a technique in which, in a power supply for discharge machining, a machining surface of 1 micrometer Rmax or less can be obtained by applying a high-frequency voltage from 1.0 megahertz to 5.0 megahertz to a gap between electrodes (see, for example, Patent Literature 1).

Furthermore, there has been disclosed a technique in which, in a discharge machining method and an apparatus therefor, and a capacitance variable device and an inductance variable device that can be applied to the discharge machine, a machining surface of 0.5 micrometer Rmax or less can be obtained by applying a high-frequency voltage from 7.0 megahertz to 30 megahertz to a gap between electrodes (see, for example, Patent Literature 2).

In wire discharge machines, to maintain a stable machining state, shaft feed is controlled based on a voltage between electrodes. When a wire electrode and a workpiece approach each other to start discharge, the voltage between electrodes decreases, and as the wire electrode and the workpiece further approach each other and a discharge cycle becomes shorter, that is, discharge occurs more frequently, the voltage between electrodes decreases further. Accordingly, whether a distance between electrodes is narrow or wide can be determined.

Generally, therefore, in wire discharge machines, a voltage between electrodes during machining is rectified and converted to a voltage of one polarity. It is determined, based on the height of the voltage between electrodes, whether the state between electrodes is an open state before start of discharge, a short circuit state, or a state during discharge from the start of discharge until reaching the short circuit state.

With this determination, regarding shaft feed, which is a relative positional movement between a wire electrode and a workpiece, a speed is adjusted based on the voltage between electrodes so that stable machining can be maintained. Furthermore, there has been disclosed a technique in which, even if discharge energy is small, a discharge state can be accurately detected by detecting a current between electrodes by a sensor coil and removing a superimposed offset component from the detected current (see, for example, Patent Literature 3).

Further, there has been disclosed a method of providing a shunt resistance in an energizing path from a power supply to a charging capacitor, and extracting a current flowing in the shunt resistance as a discharge detection signal (see, for example, Patent Literature 4).

However, when a high-frequency power supply is used as described above, a high-frequency voltage of several megahertz or more exceeds an operating limit of a rectifier circuit. Therefore, it is generally difficult to determine whether the state between electrodes is an open state, a state during discharge, or a short circuit state based on a rectified voltage.

That is, when a high-frequency power supply is used, there is a case where adjustment of shaft feed speed according to the voltage between electrodes becomes difficult, and a stable machining state may not be maintained. On the other hand, a specific case where the stable machining state can be maintained by using a high-frequency power supply is, for example, machining that can be performed by constant speed feeding. More specifically, there can be mentioned an example of machining in which finishing is performed by profiling a surface, which has been subjected to rough processing, such as finish machining in which variations in an amount of machining hardly occur.

However, even in the finish machining, when a required amount of machining changes due to a deformation on a workpiece, a stripe is formed on a machining surface during the constant speed feeding and a trail of the stripe remains. That is, when variations are likely to occur in the amount of machining, use of a high-frequency power supply is difficult. Furthermore, use of a high-frequency power supply is difficult even in first cut.

As described above, in wire discharge machines using a high-frequency power supply, while it is possible to improve surface roughness, problems related to the high-frequency power supply described above need to be solved in order to meet the demanding quality requirements in the market in recent years.

### CITATION LIST

### Patent Literatures

Patent Literature 1: Japanese Patent Application Laid-open No. S61-260915
Patent Literature 2: Japanese Patent Application Laid-open No. H7-9258
Patent Literature 3: Japanese Patent Application Laid-open No. 2007-044813
Patent Literature 4: Japanese Patent Application Laid-open No. S61-219521
Patent Literature 5: Japanese Patent Application Laid-open No. H07-001237
Patent Literature 6: Japanese Patent Application Laid-open No. H11-226816

### SUMMARY

### Technical Problem

Furthermore, if a detection circuit or a wire for determining a state between electrodes is provided between electrodes for controlling shaft feed, it means that a floating component is attached between electrodes, and machining becomes unstable due to the effect thereof. It leads to a formation of stripes on a machining surface and deterioration in surface roughness, and the effect thereof becomes significant in a high-frequency power supply.

The present invention has been made to solve the above problems, and an object of the present invention is to provide a wire discharge machine for a high-frequency power supply that generates discharge by applying a high-frequency voltage between electrodes, which is a gap between a wire electrode and a workpiece as the other electrode arranged opposite to each other with a predetermined gap therebetween, where the wire discharge machine includes a shaft-feed-speed control system that can machine a workpiece with high accuracy.

### Solution to Problem

To solve the above problems and achieve an object, there is provided a wire discharge machine according to the present invention that includes: a wire electrode arranged with a gap from a workpiece; and a constant-voltage power supply that applies a high-frequency voltage between the workpiece and the wire electrode, and generates discharge between the workpiece and the wire electrode by applying the high-frequency voltage to machine the workpiece, wherein the wire discharge machine further includes: a current measurement unit that measures a current value of a current flowing from the constant-voltage power supply; a determination unit that determines a state between electrodes, which is a state between the workpiece and the wire electrode, based on the measured current value and a change value in the current value; and a control unit that controls a gap between the workpiece and the wire electrode based on the determined state between electrodes.

### Advantageous Effects of Invention

According to the present invention, a state between electrodes can be determined without inserting any floating capacitance component such as a wire or a detection circuit between electrodes. Accordingly, in the wire discharge machine using a high-frequency power supply, control of a shaft feed speed with high machining accuracy becomes possible, while realizing maintenance of machining stability and prevention of deterioration in surface roughness concurrently.

### BRIEF DESCRIPTION OF DRAWINGS

FIG. 1 is a block diagram of a main circuit configuration of a shaft-feed control method according to an embodiment of the present invention.

FIG. 2 depicts a result of measuring a temporal change in a value of a current flowing in a shunt resistance by a numerical control unit when a wire electrode and a workpiece are machined.

FIG. 3 depicts a result of measuring a temporal change in a value of a current flowing in a shunt resistance by a numerical control unit when another wire electrode and a workpiece are machined.

FIG. 4 is an example of a determination method of a state between electrodes using both an absolute value of a current and a current change value.

FIG. 5 is a block diagram of a shaft-feed control method when it is determined that a state between electrodes is in an “open” state or a “discharge (large gap)” state.

FIG. 6 is a block diagram of a shaft-feed control method when it is determined that a state between electrodes is in a “discharge (stable gap)” state.

FIG. 7 is a block diagram of a shaft-feed control method when it is determined that a state between electrodes is in a “discharge (small gap)” state.

### DESCRIPTION OF EMBODIMENTS

As a method of not attaching a detection circuit and a wire thereof between electrodes to avoid the above problems, there can be considered a technique of providing a shunt resistance between a constant-voltage power supply and a switching circuit in a machining power supply and extracting a current flowing in the shunt resistance as a discharge detection signal.

However, in a case of a high-frequency power supply, change in impedance between electrodes due to the material of a workpiece, a plate thickness of the workpiece, a line diameter of a wire electrode, the material of the wire electrode, an axial position, and the height of machining fluid level are largely influenced and then a reflection current changes. Therefore, the state between electrodes cannot be determined only by a current value or only by a current change value, and it is difficult to execute shaft feed control.

Furthermore, because the high-frequency power supply oscillates at several megahertz, a change in the state between electrodes cannot be detected unless measurement is performed at a sampling cycle of several hundreds of nanoseconds, thereby making it difficult to control shaft feed. However, there has been a problem that if measurement is to be performed at a sampling cycle of several hundreds of nanoseconds, a numerical control device becomes very expensive.

Exemplary embodiments of a shaft-feed control method in a wire discharge machine using a high-frequency power supply according to the present invention will be explained below in detail with reference to the accompanying drawings. The present invention is not limited to the embodiments.

### Embodiment

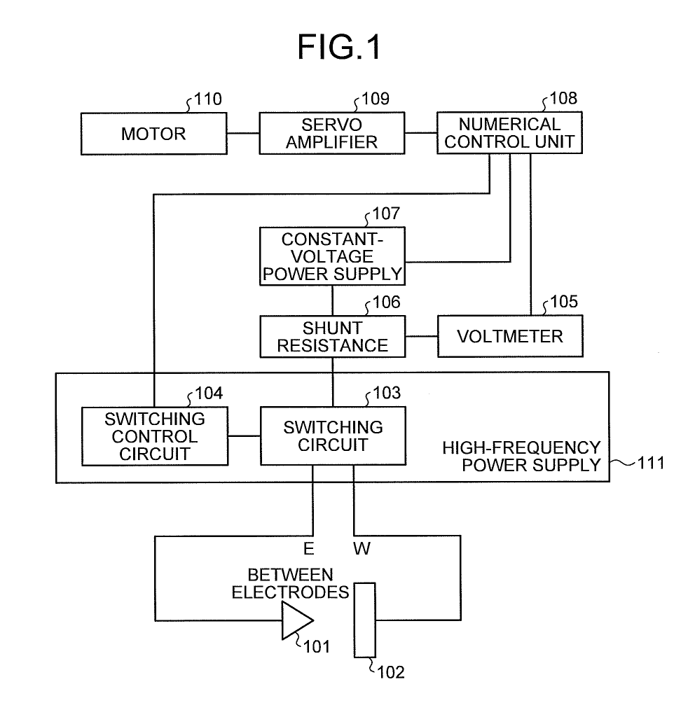

FIG. 1 is a block diagram of a circuit configuration of a shaft-feed control method of a wire discharge machine according to an embodiment of the present invention. A high-frequency power supply 111 is connected between a wire electrode 101 and a workpiece 102. The high-frequency power supply 111 includes a switching circuit 103 that performs high-frequency switching, and a switching control circuit 104 that controls switching of the switching circuit 103.

A constant-voltage power supply 107 supplies a voltage to the switching circuit 103, and a shunt resistance 106 and a voltmeter 105 are arranged between the constant-voltage power supply 107 and the switching circuit 103. A numerical control unit 108 measures a current between the constant-voltage power supply 107 and the switching circuit 103.

The numerical control unit 108 determines a state between electrodes from an absolute value of the current and a current change value based on the measured current, and changes a command value to a servo amplifier 109 according to the determined state between electrodes, thereby changing a shaft feed speed, that is, a command speed v(t), by a motor 110. The numerical control unit 108 executes control of the shaft feed speed in this manner, thereby controlling a relative distance between the wire electrode 101 and the workpiece 102, that is, a distance between electrodes.

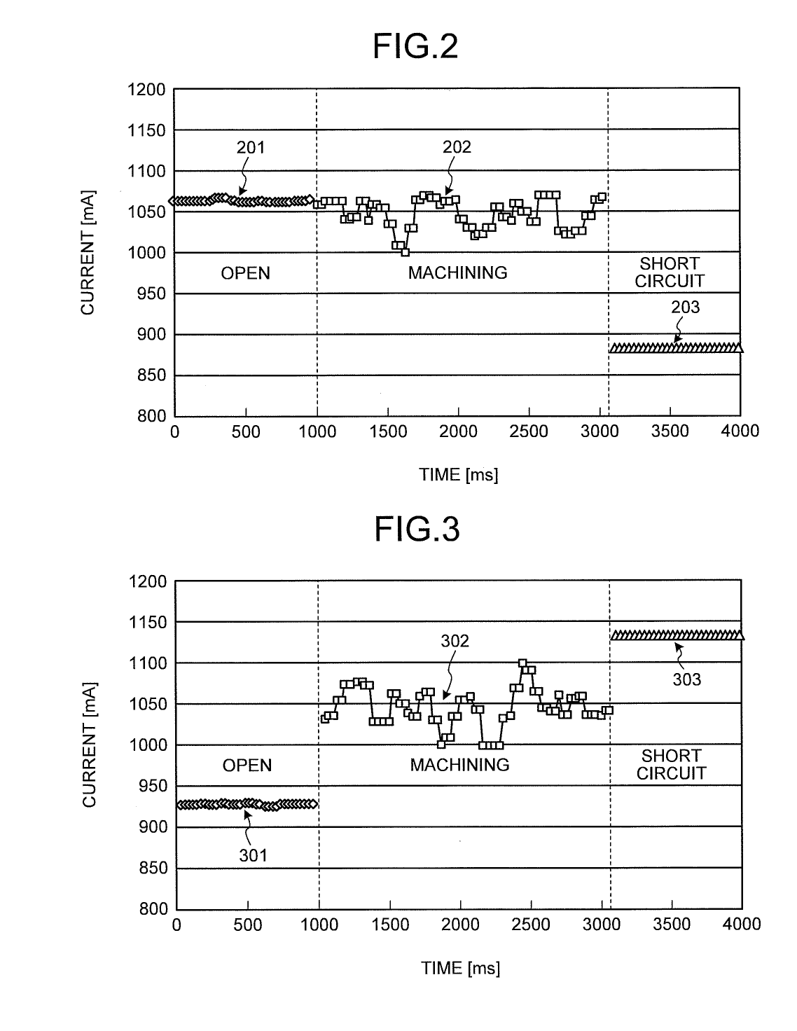

A value of the current, which is flowing in the shunt resistance 106 and is measured by the voltmeter 105, is measured by the numerical control unit 108 at a sampling cycle of several tens of milliseconds, and the result is shown in FIG. 2. The current changes with time, more specifically, the current at the time of opening changes as shown by a current time change 201, the current at the time of machining changes as shown by a current time change 202, and the current at the time of short circuit changes as shown by a current time change 203.

When the wire electrode and the workpiece are changed from a case where the result shown in FIG. 2 is acquired, a result shown in FIG. 3 is acquired. That is, the current changes with time such that the current at the time of opening changes as shown by a current time change 301, the current at the time of machining changes as shown by a current time change 302, and the current at the time of short circuit changes as shown by a current time change 303.

As can be understood from the comparison between FIG. 2 and FIG. 3, the characteristics of a temporal change in a current value at the time of opening, machining, and short circuit are different depending on the wire electrode and the workpiece. Accordingly, the state between electrodes cannot be determined based only on a current value (an absolute value of the current) or a current change value, and it is difficult to execute shaft feed control based only on any one of values thereof.

Therefore, in the present embodiment, both values of a current value (an absolute value of the current) and a current change value (a difference between the present current value and a current value measured in sampling just before that of the present current value) are used, thereby enabling to determine a state between a tool electrode such as a wire and a workpiece, that is, a state between electrodes.

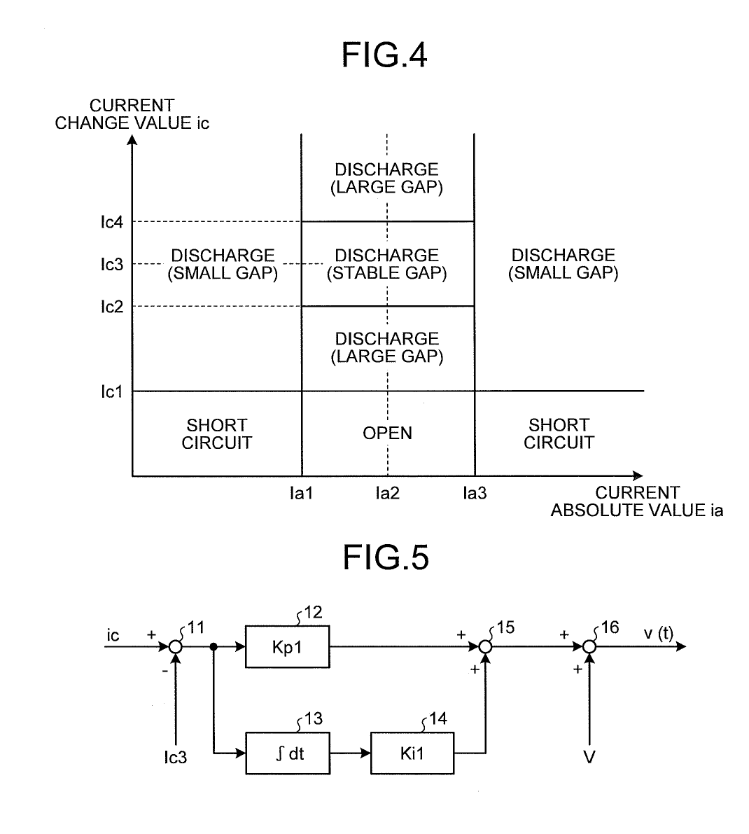

An example of a specific determination method of a state between electrodes using both an absolute value of a current and a current change value is shown in FIG. 4. The determination of the state between electrodes is made by the numerical control unit 108, for example. However, a determination unit of the state between electrodes can be provided separately from the numerical control unit 108 to cause the determination unit to make a determination. In this case, the numerical control unit 108 may be configured to control the shaft feed speed via the servo amplifier 109 and the motor 110 based on the determination result.

In FIG. 4, the horizontal axis denotes a current absolute value ia, and the vertical axis denotes a current change value ic, and each state between electrodes can be determined based on these values. In FIG. 4, Ia1, Ia2, and Ia3 denote thresholds of the current absolute value, and Ic1, Ic2, Ic3, and Ic4 denote thresholds of the current change value. These thresholds are used in a determination of the state between electrodes described below. Ia2 denotes a reference current absolute value, and Ic3 denotes a reference current change value.

For example, when the state between electrodes is “open”, that is, an “open” state, it is indicated that the current absolute value ia is between the thresholds Ia1 and Ia3 of the current absolute value, and the current change value ic is equal to or lower than the threshold Ic1 of the current change value. In other words, in this state, the current absolute value ia is, for example, within a certain width from the reference current absolute value Ia2, and the current change value ic is lower than the reference current change value Ic3 by a certain value or more.

When the state between electrodes is the discharge state and electrodes are away from each other to some extent, that is, a “discharge (large gap)” state, it is indicated that the current absolute value ia is between the thresholds Ia1 and Ia3 of the current absolute value, and the current change value ic is between the thresholds Ic1 and Ic2 of the current change value or is equal to or higher than the threshold Ic4. In other words, the current absolute value ia is, for example, within a certain width from the reference current absolute value Ia2 and the current change value ic is away from the reference current change value Ic3, for example, by a certain width or more; however, the state is not the “open” state.

When machining is stable in the discharge state, that is, a “discharge (stable gap)” state, it is indicated that the current absolute value ia is between the thresholds Ia1 and Ia3, and the current change value ic is between the thresholds Ic2 and Ic4. In other words, the current absolute value ia is, for example, within a certain width from the reference current absolute value Ia2, and the current change value ic is, for example, within a certain width from the reference current change value Ic3.

Furthermore, when the state between electrodes is a discharge state and electrodes are approaching each other to some extent, that is, a “discharge (small gap)” state, it is indicated that the current absolute value ia is equal to or lower than the threshold Ia1 or equal to or higher than the threshold Ia3. In other words, the current absolute value ia is away from the reference current absolute value Ia2 by a certain width or more, and the current change value ic is equal to or higher than the threshold Ic1.

When the state between electrodes is a “short circuit” state, the current absolute value ia is equal to or lower than the threshold Ia1 or equal to or higher than the threshold Ia3, in other words, the current absolute value ia is away from the reference current absolute value Ia2 by a certain width or more, and the current change value ic is equal to or lower than the current change value threshold Ic1.

In the present embodiment, there is provided a mechanism that detects the state between electrodes by using both an absolute value of a current and a current change value as described above, and controls shaft feed according to the machining state based on the detection result. Accordingly, highly accurate machining becomes possible in the wire discharge machine using a high-frequency power supply. As to how to configure a shaft-feed control mechanism corresponding to each state between electrodes needs to be considered here.

In the present embodiment, in the wire discharge machine using the high-frequency power supply 111, the state between electrodes is determined based on a current value of the constant-voltage power supply 107 and a current change value, and the shaft-feed control method is changed as described below based on a determination result. FIGS. 5, 6, and 7 are block diagrams of a shaft-feed control method to be applied according to each of the states between electrodes described above.

<Control Method in “Open” State and “Discharge (Large Gap)” State>

In FIG. 4, when it is determined that the state between electrodes is the “open” state or “discharge (large gap)” state, a shaft-feed control method shown in a block diagram in FIG. 5 is implemented. Kp1 denotes a proportional gain, Ki1 denotes an integral gain, V denotes a reference command speed, and v(t) denotes a command speed.

When it is determined that the state between electrodes is the “open” state or “discharge (large gap)” state, because electrodes are away from each other to some extent, control to increase the command speed v(t) is executed. Specifically, a subtracter 11 in FIG. 5 calculates a first difference by subtracting the threshold Ic3 of the current change value from the current change value ic measured by the numerical control unit 108. A multiplier 12 multiplies the first difference by the proportional gain Kp1 to obtain a value. An integrator 13 integrates the first difference and a multiplier 14 multiplies the integrated value by the integral gain Ki1 to obtain a value. Then, an adder 15 adds both values to calculate a first additional value. Finally, an adder 16 adds the first additional value to the reference command speed V to decide the command speed v(t).

That is, the difference between the current change value ic and the threshold Ic3 of the current change value is subjected to proportional integral control (proportional control/proportional-integral-derivative control), and an output thereof is added to the reference command speed V to increase the command speed v(t). Accordingly, the control to decrease the distance between electrodes is executed.

Such computation and control can be executed in hardware by actually providing computing units such as the subtracter 11 and the integrator 13 of FIG. 5 in the numerical control unit 108, or can be executed in software by a CPU or a computer program provided in the numerical control unit 108. The numerical control unit 108 performs control so that the shaft feed speed becomes the command speed v(t) described above via the servo amplifier 109 and the motor 110.

<Control Method in “Discharge (Stable Gap)” State>

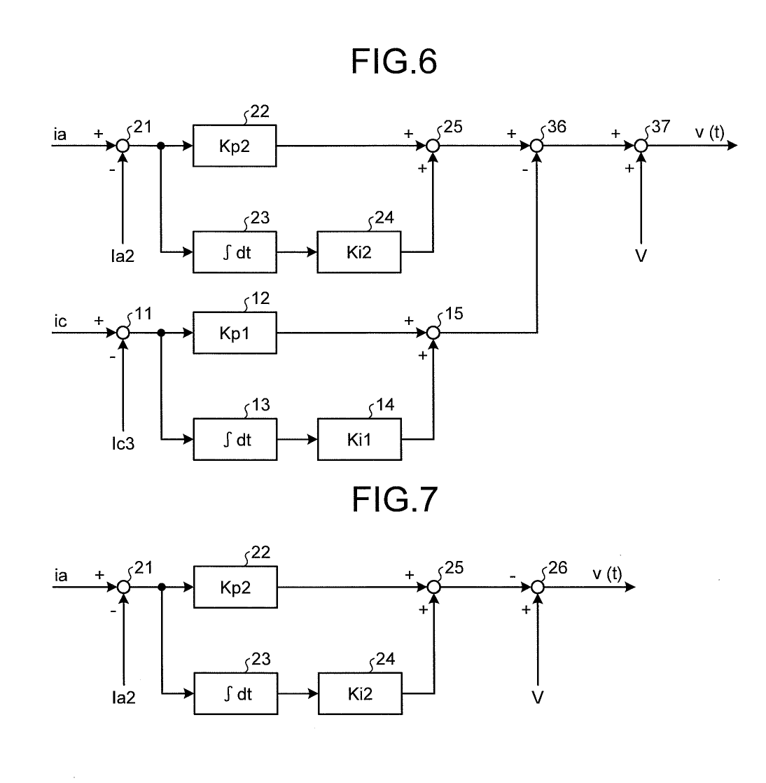

In FIG. 4, when it is determined that the state between electrodes is the “discharge (stable gap)” state, the shaft-feed control method shown in a block diagram in FIG. 6 is implemented, where Kp1 and Kp2 denote a proportional gain, Ki1 and Ki2 denote an integral gain, V denotes a reference command speed, and v(t) denotes a command speed.

When it is determined that the state between electrodes is the “discharge (stable gap)” state, the command speed v(t) is controlled so that the state between electrodes is maintained. Specifically, the subtracter 11 in FIG. 6 calculates a first difference by subtracting the threshold Ic3 of the current change value from the current change value ic measured by the numerical control unit 108. The multiplier 12 multiplies the first difference by the proportional gain Kp1 to obtain a value. The integrator 13 integrates the first difference and the multiplier 14 multiplies the integrated value by the integral gain Ki1 to obtain a value. The adder 15 then adds both values to calculate a first additional value.

Furthermore, a subtracter 21 in FIG. 6 calculates a second difference by subtracting the threshold Ia2 of the current absolute value from the current absolute value is measured by the numerical control unit 108. A multiplier 22 multiplies the second difference by the proportional gain Kp2 to obtain a value. An integrator 23 integrates the second difference and a multiplier 24 multiplies the integrated value by the integral gain Ki2 to obtain a value. Then, an adder 25 adds both values to calculate a second additional value. A subtracter 36 then calculates a value by subtracting the first additional value from the second additional value and outputs the calculated value. Finally, an adder 37 adds the output value of the subtracter 36 to the reference command speed V to decide the command speed v(t).

That is, the difference between the current change value ic and the threshold Ic3 of the current change value is subjected to proportional integral control (proportional control/proportional-integral-derivative control), the difference between the current absolute value ia and the threshold Ia2 of the current absolute value is subjected to proportional integral control (proportional control/proportional-integral-derivative control), and a difference between respective outputs thereof is added to the reference command speed V to decide the command speed v(t). Accordingly, the distance between electrodes is controlled so that the state between electrodes is maintained in the “discharge (stable gap)” state.

Such computation and control can be executed in hardware by actually providing computing units such as the subtracters 11 and 21 and the integrators 13 and 23 in FIG. 6 in the numerical control unit 108, or can be executed in software by a CPU or a computer program provided in the numerical control unit 108. The numerical control unit 108 performs control so that the shaft feed speed becomes the command speed v(t) described above via the servo amplifier 109 and the motor 110.

<Control Method in “Discharge (Small Gap)” State>

In FIG. 4, when it is determined that the state between electrodes is the “discharge (small gap)” state, the shaft-feed control method shown in a block diagram in FIG. 7 is implemented. Kp2 denotes a proportional gain, Ki2 denotes an integral gain, V denotes a reference command speed, and v(t) denotes a command speed.

When it is determined that the state between electrodes is the “discharge (small gap)” state, because electrodes approach to each other to some extent, control to decrease the command speed v(t) is executed. Specifically, the subtracter 21 in FIG. 7 calculates a second difference by subtracting the threshold Ia2 of the current absolute value from the current absolute value ia measured by the numerical control unit 108. The multiplier 22 multiplies the second difference by the proportional gain Kp2 to obtain a value. The integrator 23 integrates the second difference and the multiplier 24 multiplies the integrated value by the integral gain Ki2 to obtain a value. The adder 25 then adds both values to calculate a second additional value. Finally, a subtracter 26 subtracts the second additional value from the reference command speed V to decide the command speed v(t).

That is, the difference between the current absolute value ia and the threshold Ia2 of the current absolute value is subjected to proportional integral control (proportional control/proportional-integral-derivative control), and an output thereof is subtracted from the reference command speed V to decrease the command speed v(t). Accordingly, the control to increase the distance between electrodes is executed.

Such computation and control can be executed in hardware by actually providing computing units such as the subtracter 21 and the integrator 23 of FIG. 7 in the numerical control unit 108, or can be executed in software by a CPU or a computer program provided in the numerical control unit 108. The numerical control unit 108 performs control so that the shaft feed speed becomes the command speed v(t) described above via the servo amplifier 109 and the motor 110.

<Control method in “short circuit” state>

In FIG. 4, when it is determined that the state between electrodes is the “short circuit” state, shaft feed is reverted until the state between electrodes becomes the state other than the “short circuit” state.

As explained above, in the present embodiment, the numerical control unit 108 decides the shaft feed speed v(t) according to the determination result of the state between electrodes based on both an absolute value of a current and a current change value, and transmits a drive signal to the servo amplifier 109. Accordingly, the motor 110 controls a relative distance between the wire electrode 101 and the workpiece 102.

Conventionally, in order to perform stable machining by a wire discharge machine, shaft feed needs to be controlled by using a voltage between electrodes or the like to adjust the distance between electrodes of a machining electrode and a workpiece. However, a high-frequency power supply is susceptible to the effect of floating components between electrodes. Therefore, even by adding a circuit for taking in the voltage between electrodes, there are adverse effects such that machining becomes unstable and surface roughness is deteriorated.

To solve these problems, in the present embodiment, any circuit is not attached between electrodes, and the state between electrodes is determined based on an absolute value of a current and a change in a current from a constant-voltage power supply, which is a power supply source of a high-frequency power supply, to execute control instead of servo control on the voltage between electrodes. That is, a numerical control (NC) unit executes the following shaft-feed speed control, depending on the absolute value of the current and the change in the current from the constant-voltage power supply.

That is, when the state between electrodes is the “open” state or “discharge (large gap)” state, an error between a reference current change value and the present current change value is calculated to increase the shaft feed speed by performing a processing such as proportional integral control. When the state between electrodes is the “discharge (small gap)” state, an error between the reference current absolute value and the present current absolute value is calculated to decrease the shaft feed speed by performing a processing such as proportional integral control. When the state between electrodes is the “short circuit” state, shaft feed is reverted until the state between electrodes becomes a state other than the “short circuit” state.

As described above, in the present embodiment, the wire discharge machine that applies a high-frequency voltage between electrodes includes, between a constant-voltage power supply and a high-frequency power supply that applies a high-frequency voltage between electrodes, a shunt resistance that detects a current and a voltmeter that measures an output of the shunt resistance. A numerical control unit that analyzes a detection result is also provided to determine a state between electrodes based on a measured current value and a current change value, thereby changing the shaft-feed control method according to the determined state between electrodes.

By implementing such a shaft-feed speed control method, the wire discharge machine using a high-frequency power supply can execute shaft-feed speed control according to a discharge state between electrodes. Accordingly, so-called servo control on a gap between electrodes, which is generally executed, can be similarly executed. Therefore, even when first cut is performed or variations are likely to occur in the amount of machining, stable machining can be realized. In addition, because a circuit for determining the state between electrodes is not provided between electrodes, machining is not affected unnecessary floating components, thereby enabling to prevent occurrence of unstable machining or deterioration in surface roughness.

Furthermore, the invention of the present application is not limited to the embodiment described above, and the present invention can be variously modified without departing from the scope thereof when it is implemented in practice. Further, in the embodiment described above, inventions of various stages are included, and various inventions can be extracted by appropriately combining a plurality of elements disclosed therein. For example, even when some elements are omitted from all of the elements described in the embodiments, as far as the problems mentioned in the section of Solution to Problem can be solved and effects mentioned in the section of Advantageous Effects of Invention are obtained, the configuration from which these elements have been omitted can be extracted as an invention. In addition, constituent elements common to different embodiments can be appropriately combined.

### INDUSTRIAL APPLICABILITY

As described above, the wire discharge machine according to the present invention is useful for a wire discharge machine that executes shaft-feed speed control, and is particularly suitable for a wire discharge machine that performs fine machining by using a high-frequency power supply.

### REFERENCE SIGNS LIST

101 wire electrode
102 workpiece
103 switching circuit
104 switching control circuit
105 voltmeter
106 shunt resistance
107 constant-voltage power supply
108 numerical control unit
109 servo amplifier
110 motor
111 high-frequency power supply
201, 202, 203, 301, 302, 303 current time change
11, 21 subtracter
12, 22, 14, 24 multiplier
13, 23 integrator
15, 25 adder

1-6. (canceled)

7. A wire discharge machine that comprises:
a wire electrode arranged with a gap from a workpiece; and
a constant-voltage power supply that applies a high-frequency voltage between the workpiece and the wire electrode, and
generates discharge between the workpiece and the wire electrode by applying the high-frequency voltage to machine the workpiece, wherein
the wire discharge machine further comprises:
a current measurement unit that measures a current value of a current flowing from the constant-voltage power supply;
a determination unit that determines a state between electrodes, which is a state between the workpiece and the wire electrode, based on a combination of a result of a threshold determination of the measured current value and a result of a threshold determination of a change value in the current value; and
a control unit that controls a gap between the workpiece and the wire electrode based on the determined state between electrodes.

8. The wire discharge machine according to claim 7, comprising
a switching circuit that applies a high-frequency voltage between the workpiece and the wire electrode, wherein
the current measurement unit includes a current detection resistance connected between the constant-voltage power supply and the switching circuit, and a voltmeter that measures a voltage of the current detection resistance.

9. The wire discharge machine according to claim 7, wherein, when the state between electrodes determined by the determination unit is an open state, or a discharge state where the gap is larger than a value in a desired range, the control unit performs control so as to decrease the gap based on a difference between the change value and a threshold of a current change value.

10. The wire discharge machine according to claim 7, wherein, when the state between electrodes determined by the determination unit is a discharge state and the gap is smaller than a value in a desired range, the control unit performs control so as to increase the gap based on a difference between an absolute value of the current value and a threshold of a current absolute value.

11. The wire discharge machine according to claim 7, wherein, when the state between electrodes determined by the determination unit is a discharge state and a value of the gap is in a desired range, the control unit performs control so as to maintain the gap at a value in a desired range based on a difference between the change value and a threshold of a current change value and based on a difference between an absolute value of the current value and a threshold of a current absolute value.

12. The wire discharge machine according to claim 7, wherein, when the state between electrodes determined by the determination unit is a short circuit state, the control unit performs control so as to increase the gap until the state between electrodes is not a short circuit state.
